(19) United States
(12) Patent Application Publication
(10) Pub. No.: US 2012/0080624 A1
(43) Pub. Date: Apr. 5, 2012

(54) Solenoid Device and Driver Assistance Device

(75) Inventors: Wolf Stahr, Abstatt (DE); Michael Eisenlauer, Affalterbach (DE)

(73) Assignee: Robert Bosch GmbH, Stuttgart (DE)

(21) Appl. No.: 13/247,639

(22) Filed: Sep. 28, 2011

(30) Foreign Application Priority Data
Sep. 30, 2010 (DE) 10 2010 041 787.4

(51) Int. Cl. F16K 31/02; H01F 7/08

(52) U.S. Cl. 251/129.15; 335/277

(57) ABSTRACT

A solenoid device having an armature and a corresponding armature element which is arranged on the inside of the armature is disclosed. The armature and the corresponding armature element can be moved in relation to one another. An intermediate element which is provided for producing a supporting contact with the corresponding armature element is mounted in an axially movable fashion in a guide recess in the armature, and the intermediate element is operatively connected, on its side facing away from the corresponding armature element to a spring element. The intermediate element is at least partially conical. A driver assistance device is also disclosed.

This application claims priority under 35 U.S.C. §119 to German patent application no. DE 10 2010 041 787.4, filed on Sep. 30, 2010 in Germany, the disclosure of which is incorporated herein by reference in its entirety.

### BACKGROUND

The disclosure relates to a solenoid device having an armature and a corresponding armature element which is arranged on the inside of the armature, wherein the armature and the corresponding armature element can be moved relative to one another, an intermediate element which is provided for producing a supporting contact with the corresponding armature element is mounted in an axially movable fashion in a guide recess in the armature, and the intermediate element is operatively connected, on its side facing away from the corresponding armature element to a spring element. The disclosure also relates to a driver assistance device.

Solenoid devices of the type mentioned at the beginning are known from the prior art. They can, for example, be a component of solenoid valves or each be embodied as a solenoid valve, wherein the solenoid valves can in turn be used for driver assistance devices, in particular ABS, TCS or ESP devices. The solenoid device has the armature which can be moved in relation to the corresponding armature element. In such a case, often only the armature can be moved while the corresponding armature element is arranged in a fixed fashion. The corresponding armature element can be embodied, for example, as a pole core. In order to bring about the relative movement of the armature and corresponding armature element, the two elements interact. For this purpose, for example, the corresponding armature element has one or more coils, while the armature is composed of a magnetizable or magnetic material. The corresponding armature element is provided on the end side of the armature. The armature and the corresponding armature element are usually arranged in relation to one another in such a way that, regardless of the movement of the armature and of the corresponding armature element in relation to one another, they cannot be connected to one another. Accordingly, a gap, referred to as the air gap or working air gap, is present between the armature and the corresponding armature element or that end side of the armature which faces the corresponding armature element and that end side of the corresponding armature element which faces the armature, that is to say the armature end side and the corresponding armature element end side. The size of the air gap is dependent on the position of the armature in relation to the corresponding armature element. The size of the air gap accordingly changes when the armature and the corresponding armature element move in relation to one another. The term air gap does not mean that the gap which is present between the armature end side and the corresponding armature end side is actually filled with air. Instead, it can be filled with any desired media and serves merely to maintain a distance between the armature and the corresponding armature element.

The armature and the corresponding armature element together form an actuating device. The magnetic force which can be generated by this actuating device, and which brings about the movement of the armature and corresponding armature element in relation to one another, is characterized by the size of the air gap. This means that the magnetic force is dependent on the size of the air gap, wherein the magnetic force increases very greatly—usually exponentially—as the air gap becomes smaller. This strong increase as the air gap becomes smaller makes it more difficult for the solenoid device to have a continuous adjustment capability or to be proportionalized.

The solenoid device usually has the spring element which brings about a spring force which pushes the armature in the direction of a certain position. If the solenoid device is embodied as a solenoid valve, the solenoid valve can be, for example, a solenoid valve which is closed in the currentless state. In said solenoid valve, the spring force is directed in such a way that the armature is pushed in the direction of a closed position in which a sealing element of the solenoid valve fits into a valve seat of the solenoid valve, with the result that a valve opening is closed. However, the solenoid valve can alternatively also be embodied as a solenoid valve which is open in the currentless state and in which the spring force pushes the armature in the direction of an open position in which the sealing element clears the valve seat. During the production or assembly of the solenoid device it is necessary to set a prestress of the spring element. In the case of solenoid devices which are known from the prior art, this involves considerable expenditure. The setting of the spring force or of the prestress can be simplified by arranging the intermediate element in the guide recess, said intermediate element being provided to produce a supporting contact with the corresponding armature element. The intermediate element is mounted in an axially movable fashion here, and it can therefore be displaced within the guide recess.

It is accordingly no longer necessary to arrange a spring element directly between the armature and the corresponding armature element. Instead, the operative connection between the armature and the corresponding armature element is produced via the intermediate element to which the spring element applies the spring force. It is therefore possible, for example in the case of a solenoid valve which is closed in the currentless state, to cause the armature to be pushed away from the corresponding armature element when the solenoid valve is not energized, that is to say no magnetic force is generated by means of the actuating device or the magnetic force which is generated is smaller than the spring force which is brought about by the spring element. The spring force or prestress can be set, for example, by iterative pressing of the sealing element into the armature when the sealing element is provided on the armature in such a way that the spring element is supported on its side facing away from the intermediate element on the sealing element. In the mounted solenoid device, the spring force is consequently generated by means of a prestress of the armature, of the sealing element and of the intermediate element between the valve seat and the corresponding armature element. The spring element can preferably be arranged in the guide recess.

However, in such solenoid devices there is frequently the problem that a force/travel measurement is subject to a large degree of hysteresis during the adjustment process, in particular of the prestress. This means that the reproducibility of the relationship between the force and the travel is very poor or the variation in the measured values is very large. However, this makes the setting of the solenoid device, in particular of the prestress of the spring element, very complex and tedious.

### SUMMARY

In contrast, the solenoid device having the features of set forth below has the advantage that the hysteresis of the force/travel measurement during adjustment is improved, that is to say reduced, and the reproducibility of the measured values is improved. This is achieved according to the disclosure in that the intermediate element is at least partially conical. This means that the intermediate element has at least one region which has the shape of a cone. Cone is understood here to be, in particular, a cone or a frustum. The cone particularly preferably has a circular cross section, that is to say is in the form of a circular cone or of a circular frustum. As a result of the conical configuration at least of the region of the intermediate element, the friction of the intermediate element in the guide recess can be significantly reduced. As a result of the reduced fraction, improved reproducibility of the relationship between the force and the travel, in particular during the setting of the solenoid device, is implemented. The hysteresis is therefore also reduced.

One development of the disclosure provides that the intermediate element engages through a through-opening which is provided on that side of the armature which faces the corresponding armature element, wherein the through-opening forms a radial guide for the intermediate element. In addition to the guide recess, the through-opening is therefore formed in the armature. Both the guide recess and the through-opening are preferably formed by the same recess which, for this purpose, is present, for example, as a stepped drilled hole in the armature. In order to make available the radial guide of the intermediate element by the through-opening, a larger region of the intermediate element is preferably present in the latter in the axial direction of the intermediate element than in the guide recess. The through-opening engages, for example, through the end side of the armature which faces the corresponding armature element. The through-opening is matched to the dimensions of the intermediate element in such a way that the movement of the intermediate element in the axial direction is regularly possible, but it is held securely in the radial direction.

The radial guide is formed, for example, by virtue of the fact that the dimensions of the intermediate element correspond essentially to the dimensions of the through-opening, with the result that the intermediate element rests on the wall of the through-opening. However, it is particularly advantageous if the intermediate element has dimensions which only partially correspond to the dimensions of the through-opening, with the result that the radial guide is present only in one region of the intermediate element. It is accordingly not provided for the intermediate element to bear on all the wall of the through-opening in order to form the radial guide, but instead the latter is provided only for a region of the intermediate element which extends in the axial direction.

One development of the disclosure provides that the cross section of the through-opening is small compared to the cross section of the guide recess. In this way, an end stop for the intermediate element is formed in the armature, which end stop limits the movement of said intermediate element in the axial direction. For this purpose, a region of the intermediate element which faces away from the corresponding armature element is larger than the through-opening, with the result that it cannot pass through the latter.

One development of the disclosure provides that the guide recess has, on its side facing the through-opening, an at least partially conical region with a reduced cross section. The region with a reduced cross section is provided for adapting the cross section of the guide recess to the cross section of the through-opening. In this context, a continuous profile of the cross section is to be present in the region with a reduced cross section, with the result that the cross section of the guide recess continuously approaches the cross section of the through-opening in the axial direction over the extent of the region with a reduced cross section.

One development of the disclosure provides that in at least one position of the armature and corresponding armature element in relation to one another the conical region of the intermediate element is arranged at least partially in the region with a reduced cross section, and in particular is in centering contact with a wall of the region with a reduced cross section. The position is preferably here that position in which the spring force of the spring element pushes the armature or the corresponding armature element. In this position, the conical region of the intermediate element is to be arranged in the region with a reduced cross section which is also conical. It is particularly advantageous here if the intermediate element is in contact in this position with a wall of the region with a reduced cross section, with the result that the intermediate element is centered with respect to the armature. The contact is accordingly to be interpreted as centering contact.

One development of the disclosure provides that the intermediate element has in its lateral surface at least one axial groove which is open at the edge and engages at least partially over the longitudinal extent of the intermediate element. When the armature and corresponding armature element move in relation to one another, the intermediate element is usually also moved in the guide recess. In order to avoid a rise in pressure or a drop in pressure in the guide recess, pressure equalization must be ensured between the guide recess and surrounding regions of the solenoid device. The pressure equalization is particularly preferably produced by means of the at least one axial groove in the intermediate element. The flow path is defined here by the axial groove and an inner wall of the armature. The axial groove is present with an open edge in the lateral surface of the intermediate element, with the result that the fluid present in the solenoid device can flow over the intermediate element in the axial direction. This means that the fluid can both exit the guide recess and also enter it. A plurality of axial grooves are preferably provided, said axial grooves being arranged distributed uniformly over the circumference of the intermediate element. For example, at least two axial grooves are provided, with said axial grooves lying diametrically opposite one another.

One development of the disclosure provides that the intermediate element is provided for producing the supporting contact, and the supporting contact is produced via a tilting bearing which is provided on the intermediate element, wherein the intermediate element has, on its side facing the corresponding armature element, a contact region with a reduced cross section for the purpose of forming the tilting bearing. The intermediate element is provided for producing the supporting contact, that is say can be placed in supporting contact with the corresponding armature element. In this context, the supporting contact is to be produced via the tilting bearing. This means that the intermediate element enters into contact with the corresponding armature element or rests thereon in such a way that tilting or pivoting of the intermediate element with respect to the corresponding armature element is permitted or assisted. The tilting or pivoting occurs here in particular about at least one axis which is essentially perpendicular to a longitudinal axis of the solenoid device. The axis is preferably located here in the end side of the corresponding armature element. In this way, tilting of the intermediate element with respect to the armature or the corresponding armature element cannot result in lateral forces. However, the lateral forces which occur are at least reduced. The friction forces between the intermediate element and the armature are therefore also reduced.

The tilting bearing can in principle be configured in any desired way. All that is necessary is to permit the tilting of the intermediate element with respect to the corresponding armature element as described above in such a way that tilting of this type does not bring about or favor the occurrence of the lateral forces. The tilting bearing is preferably formed by the contact region with a reduced cross section. For this purpose the intermediate element can be spherical, in the shape of a spherical section, or conical in the region of the contact region. The contact region with a reduced cross section is to be understood in particular here as meaning that the cross section of the intermediate element is reduced, for example continuously, in the direction of the corresponding armature element. The contact region, in which the intermediate element enters into supporting contact with the corresponding armature element in order to form the tilting bearing, accordingly has a smaller cross section than regions of the intermediate element which face away from the corresponding armature element. Given a continuous reduction in the cross section of the intermediate element, there is, in particular, a conical shape of the intermediate element. The intermediate element is therefore configured in a conical shape in the region of the contact region. However, it has also proven advantageous to configure the intermediate element in the region of the contact region in a spherical shape or in the shape of a spherical section.

One development of the disclosure provides that an air gap is present between an armature end side and a corresponding armature element end side, wherein a disk which can be placed at least partially in contact with the armature end side and the corresponding armature element end side and is composed of a magnetizable and/or flexurally weak material is arranged in the air gap. As already stated above, the air gap is present between the armature end side and the corresponding armature element end side. A disk which can be placed at least partially in contact with the armature end side and corresponding armature element end side is to be arranged in said air gap. The disk is present between the armature and the corresponding armature element when viewed in the axial direction of the solenoid device. In other words, a disk which is at least partially in contact with the armature end side and/or the corresponding armature element end side in at least one relative position of the armature and corresponding armature element is arranged in the air gap. The disk can have a central recess here, which recess serves, in particular, to receive the intermediate element and/or the spring element.

The disk is preferably composed of a material which can be magnetized well, for example a metal, and is provided, in particular, for transmitting the magnetic flux which is present in the air gap. If both the armature end side and the corresponding armature element end side are in contact with the disk, a magnetic shunt is present, through which the adjustability of the solenoid device is improved. However, in this context, the disk will preferably oppose the relative movement of the armature and corresponding armature element with respect to one another with the smallest force possible. For this reason, the disk can ideally be deformed in the axial direction with a small application of force, that is to say the disk has a small degree of rigidity in this direction. The material is accordingly preferably flexurally soft. Nevertheless, the disk is to be elastic such that when the deforming force ceases the deformation is reversed, that is to say the disk provides the corresponding restoring force or has the corresponding elasticity.

One development of the disclosure provides that the solenoid device is a solenoid valve, wherein the armature is operatively connected to a sealing element of the solenoid valve in order to move same. In this way, when the armature moves with respect to the corresponding armature element, the sealing element is also moved. The sealing element is usually provided for closing or clearing a valve opening of the solenoid valve. If the sealing element is arranged so as to close the valve opening, it is usually seated in a valve seat of the solenoid valve, which valve seat is assigned both to the valve opening and to the sealing element. For example, the sealing element is inserted into a recess in the armature and held therein, wherein the recess is preferably provided on a side of the armature which faces away from the corresponding armature element.

The disclosure also relates to a driver assistance device, in particular ABS, TCS or ESP device, having at least one solenoid device which is embodied as a solenoid valve, in particular according to the present embodiments, wherein the solenoid device has an armature and a corresponding armature element which is arranged on the end side of the armature. The armature and the corresponding armature element can be moved relative to one another, and an intermediate element which is provided for producing a supporting contact with the corresponding armature element is mounted in an axially movable fashion in a guide recess in the armature, and the intermediate element is operatively connected on its side facing away from the corresponding armature element to a spring element. In this context there is provision that the intermediate element is at least partially conical. The solenoid device of the driver assistance device can be embodied according to the statements above.

### BRIEF DESCRIPTION OF THE DRAWINGS

The disclosure will be explained in more detail with reference to the exemplary embodiments illustrated in the drawing, without restricting the disclosure. In this context:

FIG. 1 shows a cross section through a solenoid device which is embodied as a solenoid valve, wherein an intermediate element is arranged in a guide recess in the armature,

FIG. 2 shows a sectional view of a detail of the solenoid device in the region of the armature, and

FIG. 3 shows the intermediate element which is known from FIGS. 1 and 2.

### DETAILED DESCRIPTION

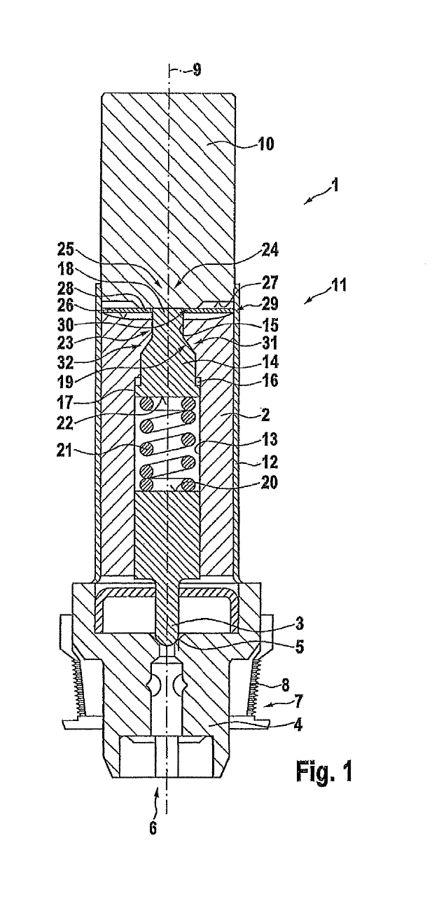

FIG. 1 shows a solenoid device 1 which is embodied as a solenoid valve, wherein the solenoid valve is, for example, a component of a driver assistance device (not illustrated here). The solenoid device 1 has an armature 2 which is operatively connected to a sealing element 3 of the solenoid valve. The sealing element 3 interacts with a valve seat 5 which is formed in a valve body 4, in order to clear or interrupt a flow connection between an outlet connection 6 and an inlet connection 7 of the solenoid valve. In the exemplary embodiment illustrated here, a filter 8 is assigned to the inlet connection 7. Additionally or alternatively, it is, of course, also possible for a filter (not illustrated here) to be assigned to the outlet connection 6. The solenoid device 1 illustrated here is configured for a radial inflow and an axial outflow (with respect to a longitudinal axis 9 of the solenoid device 1) depending on the arrangement of the outlet connection 6 and inlet connection 7. However, the inflow direction or the outflow direction can, of course, also be provided as desired, that is to say the outlet connection 6 can be used as an inlet connection and the inlet connection 7 can be used as an outlet connection.

In addition to the armature 2, the solenoid device 1 has a corresponding armature element 10 which, together with the armature 2, forms an actuating device 11 of the solenoid device 1. The corresponding armature element 10 is embodied, for example, as a pole core and has at least one electric coil, with the result that a magnetic force can be applied to the armature 2 by means of the corresponding armature element 10 by applying a voltage to the coil (that is to say by energizing the solenoid device 1). The armature 2 is mounted in an axially displaceable fashion with respect to the longitudinal axis 9, wherein the bearing is implemented, in particular, by means of a housing 12 of the solenoid device 1. In this context, the corresponding armature element 10 and the valve body 4 are also secured to the housing 12 in a positionally fixed fashion. The armature 2 can therefore be moved in the axial direction in relation to the armature 2 or the valve body 4 under the influence of the magnetic force generated by means of the corresponding armature element 10. The solenoid valve, which is illustrated in FIG. 1, is a solenoid valve which is closed in the currentless state. This means that the sealing element 3 is seated in a sealing fashion in the valve seat 5 as long as the solenoid valve is not energized, that is to say no magnetic force is generated by means of the corresponding armature element 10.

In order to improve the adjustability during the production of the solenoid device 1, an intermediate element 14 is arranged in a guide recess 13 in the armature 2. In this context, the intermediate element 14 is mounted in an axially movable fashion and can enter into supporting contact with the corresponding armature element 10. In addition to the guide recess 13, the armature 2 has a through-opening 15, wherein the guide recess 13 and the through-opening 15 are preferably formed by a stepped drilled hole 16. The through-opening 15 has a smaller cross section than the guide recess 13, in particular it therefore has a smaller diameter. At the same time, the intermediate element 14 is composed of a guide section 17 and a through-section 18. The guide section 17 is arranged in the guide recess 13 while the through-section 18 is partially present in the through-opening 15. The guide section 17 has here a larger cross section, in particular a larger diameter, than the through-section 18. In this respect, an end stop 19 for the intermediate element 14 is formed in the armature 2. The end stop 19 prevents the intermediate element 14 from being able to move out of the armature 2 or the stepped drilled hole 16 in the direction of the corresponding armature element 10. However, it is, of course, also possible to dispense with the formation of the end stop 19. As a result of the small dimensions of the through-section 18 compared to the guide section 17, virtually the entire pole face (in the form of the surface of the end side of the corresponding armature element 10) is available for transmitting the magnetic force.

On the side of the armature 2 facing away from the intermediate element 14 the sealing element 3 is inserted into the stepped drilled hole 16. In this context, the sealing element 3 is preferably pressed into the stepped drilled hole 16, with the result that it is held therein in a clamping fashion. The sealing element 3 has on its side facing away from the valve seat 5, a supporting face 20 for a spring element 21 which is arranged between the sealing element 3 and the intermediate element 14. The intermediate element 14 has here a supporting face 22 for the spring element 21. In the embodiment of the solenoid device 1 presented here, a prestress of the spring element 21, which is embodied, for example, as a helical spring, can be set by pressing the sealing element 3 into the armature 2. In the region of the through-opening 15 through which the intermediate element 14 engages, the dimensions of the through-opening 15 are reduced, in particular adapted to the dimensions of the intermediate element 14 in such a way that a radial guide 23 is formed.

A contact region 24 with a reduced cross section is provided on the intermediate element 14, which contact region 24 can enter into contact with the corresponding armature element 10 in order to produce the supporting contact between the intermediate element 14 and the corresponding armature element. As a result of the shape of the contact region 24 with a reduced cross section, a tilting bearing 25 is provided by means of which the supporting contact is produced. The tilting bearing 25 allows the intermediate element 14 and the corresponding armature element 10 to tilt with respect to one another without transverse forces, which increase the friction forces between the intermediate element 14 and the armature 2, occurring. The tilting bearing 25 therefore serves to reduce friction forces between the intermediate element 14 and the armature 2.

The spring element 21 brings about a spring force which acts on the intermediate element 14, in which case said spring element 21 is supported on the sealing element 3 which is arranged in a positionally fixed fashion with respect to the armature 2. The spring force pushes the intermediate element 14 in the direction of the corresponding armature element 10. If the solenoid device 1 is energized, and if the corresponding magnetic force which is directed in the direction of the corresponding armature element 10 in the exemplary embodiment illustrated here therefore acts on the armature 2, the armature 2 is moved toward the corresponding armature element 10. As soon as the armature 2 has reached an axial position with respect to the corresponding armature element 10 in which the intermediate element 14 is in contact or supporting contact with the corresponding armature element 10, the intermediate element 14 is moved into the guide recess 13, that is to say toward the sealing element 3. In this context, the spring element 21 is stressed further. If the magnetic force is removed, the spring force therefore causes the armature 2 to be pushed away from the corresponding armature element 10 again. In the embodiment proposed here, the resetting of the armature 2 by means of the intermediate element 14 is therefore implemented, wherein the intermediate element 14 is continuously in supporting contact with the corresponding armature element 10. However, it is also possible to provide that a further spring element (not illustrated here) is used for the resetting process. In particular in this case, the intermediate element 14 can be spaced apart from the corresponding armature element 10 in at least one position of the armature 2 and can enter into supporting contact with the corresponding armature element 10 only when the armature 2 and the corresponding armature element 10 move toward one another.

In order to improve the adjustability of the solenoid device 1, a disk 28 which can be at least partially placed in contact with the armature end side 26 and the corresponding armature element end side 27 is arranged in the air gap which is present between the armature 2 and the corresponding armature element 10, or between an armature end side 26 and a corresponding armature element end side 27. In the case of the solenoid device 1 illustrated in FIG. 1, there is provision that the contact is present in every relative position of the armature 2 and corresponding armature element 10 in relation to one another. However, it is, of course, also possible to form the solenoid device 1 without the disk 28. The armature end side 26 is of concave design, that is to say curves in such a way that at its centre point it is at a maximum distance from the corresponding armature element 10. The corresponding armature element end side 27 is, in contrast, of convex design, that is to say has a curvature which is directed outward, in the direction of the armature 2. The contact between the armature end side 26 and the disk 28 is present at a first contact point 29. A second contact point 30, between which contact is present between this corresponding armature element end side 27 and the disk 28, is provided further inward in the radial direction than the first contact point 29. The contacts points 29 and 30 are spaced apart from one another in the radial direction here so that there is no overlap between them.

FIG. 1 also shows that the intermediate element 14 is of at least partially conical design, that is to say has a conical region 31. This is present in the guide section 17 and serves, in particular, to reduce the dimensions as far as the dimensions present in the through-section 18. At the same time, the guide recess 13 has, on its side facing the through-opening 15, a region 32 with a reduced cross section. The latter is preferably also at least partially of conical design, preferably completely of conical design. A cone is understood here to be a cone or a frustum, particularly preferably a circular cone or a circular frustum. The solenoid device 1 is preferably embodied in such a way that in at least one position of the armature 2 and corresponding armature element 10 the conical region 31 of the intermediate element 14 is arranged at least partially in the region 32 with a reduced cross section. In this position, said conical region 31 is preferably in contact here with a wall of the region 32 with a reduced cross section. Due to the conical shape of the intermediate element 14 and the region 32 with a reduced cross section, this contact brings about centering of the intermediate element 14 with respect to the armature 2. In this respect, centering contact is present between the intermediate element 14 and the armature 2.

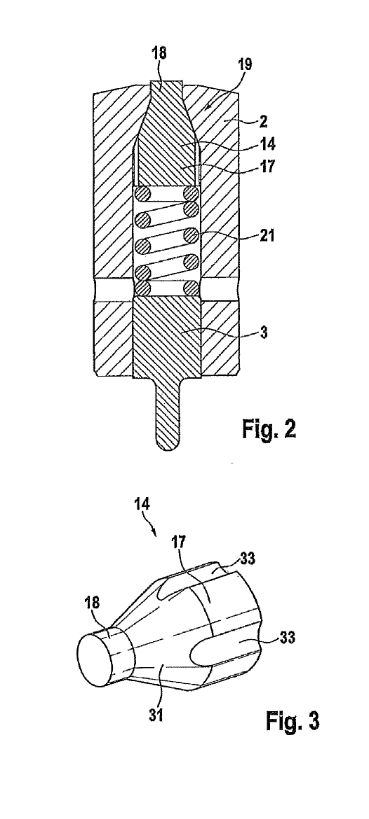

FIG. 2 shows a sectional view of a detail of the solenoid device 1 or of the armature 2, wherein apart from the armature 2 only the intermediate element 14, the sealing element 3 and the spring element 21 are illustrated. The configuration of the armature 2 and intermediate element 14 shown in FIG. 2 corresponds essentially to that described with respect to FIG. 1. In this respect, reference is made to the statements above. The end stop 19 is illustrated by the conical region 31 of the intermediate element 14 and the region 32 with a reduced cross section. The intermediate element 14 can accordingly not move out of the armature 2 in the axial direction.

FIG. 3 shows a view of a detail of the intermediate element 14. It is clearly apparent that the intermediate element 14 has axial grooves 33. In this context, four axial grooves 33 are arranged distributed uniformly over the circumference of the intermediate element 14, with two of the axial grooves 33 lying diametrically opposite one another in each case. FIG. 3 also shows the conical region 31. Overall it becomes clear that the intermediate element 14 is composed of two essentially cylindrical regions—the guide section 17 and the through-section 18—between which the conical region 31 is arranged. The interaction of the conical region 31 of the intermediate element 14 and the region 32 with a reduced cross section ensures reliable centering of the intermediate element 14 with respect to the armature 2. In this way, the friction between the intermediate element 14 and the armature 2 can be reduced. The initial position of the intermediate element 14 when a measurement is performed before the solenoid device 1 is set is therefore precisely defined, so that the results of the force travel measurement which is carried out in the process have less variation than in the case of solenoid devices 1 which are known from the prior art. The hysteresis of the measurement can also be reduced in this way. The influence of the intermediate element 14 on the hydraulic damping can be set by providing the axial grooves 33, which are present with open edges in the intermediate element 14.

What is claimed is:

1. A solenoid device, comprising:
an armature defining a guide recess;
a corresponding armature element which is arranged on the inside of the armature, the armature and the corresponding armature element being configured to be moved in relation to one another;
a spring element; and
an intermediate element configured to produce a supporting contact with the corresponding armature element and mounted in an axially movable fashion in the guide recess,
wherein the intermediate element is operatively connected, on its side facing away from the corresponding armature element, to the spring element, and
wherein the intermediate element is at least partially conical.

2. The solenoid device according to claim 1, wherein the intermediate element engages through a through-opening which is provided on the side of the armature which faces the corresponding armature element, and wherein the through-opening forms a radial guide for the intermediate element.

3. The solenoid device according to claim 1, wherein the cross section of the through-opening is small compared to the cross section of the guide recess.

4. The solenoid device according to claim 1, wherein the guide recess has, on its side facing the through-opening, an at least partially conical region with a reduced cross section.

5. The solenoid device according to claim 1, wherein in at least one position of the armature and corresponding armature element in relation to one another, the conical region of the intermediate element is arranged at least partially in the region with a reduced cross section, and in particular is in centering contact with a wall of the region with a reduced cross section.

6. The solenoid device according to claim 1, wherein the intermediate element has in its lateral surface at least one axial groove which is open at the edge and engages at least partially over the longitudinal extent of the intermediate element.

7. The solenoid device according to claim 1, wherein the intermediate element is configured to produce the supporting contact, and the supporting contact is produced via a tilting bearing which is provided on the intermediate element, and wherein the intermediate element has, on its side facing the corresponding armature element, a contact region with a reduced cross section configured to form the tilting bearing.

8. The solenoid device according to claim 1, wherein an air gap is present between an armature end side and a corresponding armature element end side, and wherein a disk which is configured to be placed at least partially in contact with the armature end side and the corresponding armature element end side and is composed of a magnetizable and/or flexurally weak material is arranged in the air gap.

9. The solenoid device claim 1, wherein the solenoid device is a solenoid valve, and wherein the armature is operatively connected to a sealing element of the solenoid valve in order to move same.

10. A driver assistance device having at least one solenoid device which is embodied as a solenoid valve, wherein the solenoid device has an armature and a corresponding armature element which is arranged on the end side of the armature, the armature and the corresponding armature element is configured to be moved in relation to one another, and an intermediate element which is configured to produce a supporting contact with the corresponding armature element is mounted in an axially movable fashion in a guide recess in the armature, and the intermediate element is operatively connected on its side facing away from the corresponding armature element, to a spring element, wherein the intermediate element is at least partially conical.

11. The driver assistance device of claim 10, wherein the driver assistance device is one of an ABS, TCS, and ESP device.
